(19) United States
(12) Patent Application Publication
(10) Pub. No.: US 2012/0170726 A1
(43) Pub. Date: Jul. 5, 2012

(54) Media Link

(75) Inventor: Joel Schwartz, Lakewood, NJ (US)

(73) Assignee: PARLOR.FM., INC., Lakewood, NJ (US)

(21) Appl. No.: 13/343,424

(22) Filed: Jan. 4, 2012

Related U.S. Application Data
(60) Provisional application No. 61/429,926, filed on Jan. 5, 2011.

(51) Int. Cl. H04M 11/00

(52) U.S. Cl. 379/93.02

(57) ABSTRACT

Two or more users can be connected over the internet or through the world-wide web or other network without the users exchanging access numbers and/or user identifications. Moreover an instant voice communication channel may be established based on the caller's device identification number or electronic signature without the need to create dedicated telephony paths or user names/passwords.

### CROSS-REFERENCE TO RELATED APPLICATION

This application claims the benefit of the filing date of U.S. Provisional Application Ser. No. 61/429,926, filed Jan. 5, 2011, the entire disclosure of which is incorporated by reference as if set forth fully herein.

### FIELD OF THE INVENTION

The present invention relates to the field of communications.

### BACKGROUND

Historically, when people wanted to share ideas they met in person. However, over the past few decades the use of conference calls has become commonplace, which has enabled businesses to become more efficient by avoiding the costs of transporting persons over large distances while still allowing them to converse in real time.

Under common methodologies, persons can only join a conference call when they are known subscribers or have access to registration information. Thus, unless a caller speaks to an operator who places the caller into the conference call, each caller must, after dialing a call-in number, enter user identification numbers and/or provide passwords to initiate and/or to participate in the discussion.

Under these circumstances dedicated communication links or facilities that are associated with the pre-established identification numbers and passwords must be maintained throughout the calls. As persons of ordinary skill in the art will readily recognize, there can be gross inefficiencies in these systems. For example, to the extent that the party or parties are not known to each other prior to the call or to the communications network, the callers' need to use traditional methods of exchanging such user identification numbers and passwords decreases the likelihood of such parties connecting with each other, and this burden can be an impediment to doing business. As a matter of practice, the presence of this impediment has caused many persons to forego availing themselves of the benefits that the world-wide-web has to offer in the field of conference calls. Thus, there remains a need to develop new technologies to which persons may turn when considering whether to engage in media links, particularly over the world-wide web or other networks.

### SUMMARY

The present invention provides technologies and methods for using the identity of a calling device such as a telephonic or computing device to authorize participation in one or more conference calls. Under a number of embodiments, each user may determine his own degree of privacy and the system may mask his identity by referring to the person only through his privacy protected handle unless and until the user allows for a less stringent degree of privacy to be applied. Thus, the present invention may be implemented as part of a media link platform that facilitates connections between callers (also referred to as users), while optionally offering them degrees of privacy with which they are comfortable.

Through use of a media-link software application code, systems and platforms can be created that allow for extraction of the identity of a device of an originating caller and/or a participating caller. The devices may be telephonic and/or computing devices (such as mobile phones). The system or platform may transfer this information through a database and can use this information to authenticate a user, to establish a set of participants to a call, to manage a call and ultimately to terminate a call. Thus, various embodiments may facilitate communication, conferencing and/or social networking sessions. Additionally, various embodiments of the present invention allow establishing connections between both people that ordinarily have access to each other's caller identification information and/or, wherein they may or may not wish to share such user and/or caller identification information.

By way of example, the connections may be used to form conference calls. Each conference call may have two or more participants, and one or more, or all of each of the callers may use a mobile or fixed telephony device, a computer, a microcomputer or a voice enabled modem that is or can be connected to the internet. The media link may enable communication that is based on voice, data, video or any combination of these communications modes on an integrated basis, and the media link may be applied to a purely telecommunications, conferencing, chat, blogging or any other social networking applications.

According to a first embodiment, the present invention provides a method for providing access to a conference call, wherein the method comprises: (a) executing a set of computer instructions stored in a non-transitory medium, wherein the computer instructions comprise (i) a first module that when initiated transmits a call-in number to one or more persons over a network; and (ii) a second module that is configured to receive telephone calls from a plurality of persons and to determine whether each telephone call is made from an authorized telephone number; and (b) connecting a person to a conference call only if the person's call originates from an authorized telephone number.

According to a second embodiment, the present invention provides a method for establishing a telephone connection between or among a plurality persons who are interested in a topic, the method comprising: (a) receiving a selection of a topic of conversation from a person; (b) transmitting to a set of one or more persons an electronic communication over a network, wherein the electronic communication comprises a notification of a conference call, information corresponding to the topic, a desired time, and an invitation to obtain a call-in telephone number; (c) receiving an acceptance of the invitation from each of a subset of persons from within the set and a proposed telephone number from each of the subset of persons; (d) providing each person within the subset, the call-in telephone number; and (e) permitting a person to join the conference call if the person calls from the proposed telephone number.

According to a third embodiment, the present invention provides a method for establishing a telephone connection between or among a plurality of persons, the method comprising: (a) receiving a selection of a topic of conversation from a person; (b) transmitting to a plurality of persons an electronic communication over a network, wherein the electronic communication comprises a notification of a conference call, a desired time, information corresponding to the topic and an invitation to obtain a call-in telephone number; (c) receiving an acceptance of the invitation from a subset of persons from within the set and dividing the subset into two or more subgroups, comprising a first subgroup and a second subgroup, wherein each subgroup comprises at least two members and providing members of the first subgroup with a first call-in number and members of the second subgroup with a second call-in number, wherein the first call-in number and the second call-in number are not the same; (d) within each subgroup, identifying each person to each other person by a privacy protected handle; and (e) providing each person with a ratings option, wherein the ratings option permits each person to provide feedback as to the quality of each other person on a conference call.

According to a fourth embodiment, the present invention provides a method for establishing a mobile call. The mobile call is a telephone connection in which a plurality of persons can listen to a speaker over a telephone system and participate by submitting or asking questions of the speaker. The speaker may for example, be selected based on ratings as to the speaker's knowledge on a topic and/or ability to present on a topic. Optionally, the speaker may control when, how or from whom questions are submitted.

According to a fifth embodiment, the present invention provides a method for permitting a person to solicit offers from merchants, the method comprising: (a) receiving electronic data over a network from a person who has access to a platform, wherein the electronic data corresponds to a request for a good or a service and the request comprises at least one of an item name, an item description, a time, a location, a number of persons and a price; (b) receiving an identification of a group of one or more merchants from the person, wherein the identification comprises a merchant name and/or description of a type of goods or services offered by the merchant; (c) transmitting the request and a privacy protected handle to all members of the group; and (d) receiving a response to the request and transmitting: (i) at least one response to the person; and (ii) an option for the person to respond to the merchant or to enter into discussions with the merchant. This method may allow a platform or system to facilitate an essentially anonymous communication from a potential customer to a group of merchants.

The methods described above may be implemented by computer systems and the instructions may be stored in computer program products. The various embodiments may be implemented on or as part of a platform e.g., an html platform. By way of non-limiting examples, these methods, systems and computer program products may enable a person of ordinary skill in the art to set up a media link that facilitates voice linking that may be used in connection with internet, social networking or other commercial websites in order to introduce the use of voice communications for instant voice communications, voice chatting and/or voice conferencing. Furthermore, because these systems may be automated, the methods may be initiated by remote users or members who have access to the systems or platforms.

Moreover, a number of the embodiments described herein offer the advantages of not being static, avoiding the need for additional levels of security and decreasing the ability for fraud in the participation of the system. Under some of these embodiments, a user may, after logging into an account that requires a user name and password: (1) create invites that may be sent to others via email or sms (group call); or (2) click an enter room, that will simultaneous send an application programming interface (API) request that: (i) grabs and displays an accesses number and (ii) tells the media link to be waiting for a call from that user (topic talk).

Furthermore, the applications of the present invention may be administered through a platform over a network such as the internet in which the access number or dial-in number is unknown prior to the API request. In some embodiments, a user is logged into the system and while logged in will dictate to the system for a group call, the persons whom the user would like to invite, providing a method for communicating to the persons (e.g. sms or email), the time for the call to take place and the date for the call to take place. After the system receives this information, it will provide the user with the access number. Persons who have been via sms or email will receive a link that is tied to that call. The system may first ask them to provide the ANI from which they intend to make the call and optionally the country from which they will be calling (in some embodiments, this information may be defaulted to a specific country and the invitee can change the country). After receiving that information, the system will send a call-in number to each invitee. Alternatively, the system could send the invite and request for the number from which the call will be made, with the call-in number.

Note that because the system tracks where to route a caller by the telephone number from which he calls in to the system, the system can simultaneously make use of the same call-in number for different group calls, while routing different people who use this number to different groups that are discussing different topics. Alternatively, the system can be configured such that it uses different call-in numbers for different group calls that are active at the same time.

Applications that implement one or plurality or all of these methods may each exist on a platform, and they may be integrated with one or more of the other embodiments, or they may exist as standalone applications. When establishing or engaging these methods one may make use of one or more of the following utilities that are optionally present: (1) a phone book; (2) a user profile; (3) a search functionality; (4) a journal functionality; and (5) a wallet. Through the various embodiments of the present invention, one may not only set up a call (including but not limited to one or more of a physical connection, security, privacy and billing) but also include the maintenance and modification of the in-process call; and the teardown of the connection.

### BRIEF DESCRIPTION OF THE DRAWING

FIG. 1 is an architecture diagram showing components of an embodiment of the present invention.

FIG. 2 is a communication protocol for devices of an embodiment of the present invention connected to the system shown in FIG. 1.

FIG. 3 is an internal view of a connection management functionality within an embodiment of the present invention.

FIG. 4 is a representation of a call state diagram.

### DETAILED DESCRIPTION

Through use of the various embodiments of the present invention one can improve the experience of communication between and among users of telephones, telephone related technologies and other communication based technologies. The disclosed technologies and methodologies may allow for one or more of increased efficiency, increased user satisfaction and sufficiently high levels of privacy.

According to a first embodiment of the present invention, one may provide access to a conference call. A conference call is an event in which a plurality of persons, e.g., at least 2, at least 3, at least 5, at least 10, at least 25, at least 50, at least 100, at least 250 or at least 500 may be able to listen to what one or more speakers have to say. Conference calls may be audio only, video only (optionally with text data such as closed captioning and/or sign language interpretation) or audio video, and they may take place over the cellular telephone lines, over landlines and/or over a network such as the internet. The phrase “conference call” does not limit the subject matter of what will be discussed or the purpose of the call. Thus, by way of example, the call may be directed to one or more of business, law, economics, medicine, social events, religion, education or networking.

In some conference calls, all participants have the option to speak and to be heard at all times, whereas in other conference calls fewer than all participants have the ability to speak and to be heard at any given time or at all times, e.g., only one person may have the ability to speak and thus when over the internet in these cases, the conference call may be referred to as a podcast. If more than one party to the conference call has the ability to speak and to be heard, one person may be moderator and have the ability to control who can be heard at any time. The moderator may or may not be able to speak and to be heard.

Participants to the conference call may gain access by dialing in from a device that is recognized by a computer as being authorized to participate in the conference call. In some embodiments, the device is recognized by the telephone number that is associated with it. Methods for determining whether a telephone number is recognized may for example make use of automatic number identification (ANI) technologies. As persons of ordinary skill in the art are aware, ANI technologies can be designed such that they are capable of capturing a telephone number even when a caller ID blocking feature is activated.

When a potential participant attempts to call in, the computer will automatically determine if the call originates from a device that is associated with a telephone number from which the call is authorized. Thus, the caller's identification is through identification of the device that is associated with a particular telephone number and not necessarily any distinguishing attribute of the caller himself. The computer will, prior to the call having been made by the potential participant, have been given or have generated a list of telephone numbers from which callers can dial in and gain access. (The phrase “dial in” is not limited by the means by which phone numbers are used or transmitted along a telephone or other network.) Because the computer checks authorization based on the originating telephone, there is no need for an access code or personal identification number (PIN), and the methods of the present invention can be carried out in the absence of them or any other identifying information. There would be no technological impediment to e.g., using a PIN, but its use would be unnecessary and potentially inefficient.

As a person of ordinary skill in the art will readily see, the aforementioned method prevents unauthorized access to a call by someone who dials from an unauthorized telephone. If the phone number is not recognized, then the system may play an automated message that indicates that access has been denied. Additionally and as is readily apparent, the system may be configured either to prevent access from all telephones that are configured to block their identification or to cause a caller who has called from a device whose identity cannot be determined. Alternatively, the system may require a caller whose device's identity cannot be determined, to provide the system with information corresponding to the phone number by for example, lifting the blocking technology, inputting the phone number on the phone keys or stating the phone number. In the latter two cases, the system would be configured with the appropriate software to determine what was input or stated.

A verification of authorization protocol may be used and may be in the form of a set of computer instructions that are stored in a non-transitory medium and that are operably coupled to a database that contains information that identifies a set of authorized telephone numbers. If a telephone number is recognized as being authorized, a gateway may be opened that enables the caller to join the applicable conference call. Thus, the database may associate an authorized telephone number with a specific call-in number. Because the system sent out the invitations, it knows which authorized telephone numbers are associated with which group. Therefore, the system can either assign one call in number to each group, or use the same call in number for a plurality of groups, e.g., at least 2, at least 3, at least 5, least 10, at least 25 groups or 2 to 100 groups, and then route the caller to the group to which he was invited. The conference call may be hosted by a telecommunications system according to technologies that are now known or that come to be known and that a person of ordinary skill in art would recognize as being of use in connection with the present invention.

When executing a method according to the present invention, a system may be configured to operate on a platform that is configured to receive from a person who seeks to initiate a conference call an identification of a set of one or more other persons whom the initiating person wishes to invite to the conference call. The set of persons may be established in any of a number of ways. For example, the initiating person may access a website and if required, become a member of a group that has access to the services offered by the website e.g., a subscriber, though a fee need not necessarily be associated with membership. Upon logging into the website, the initiating person may provide a list of persons by their email and/or telephone numbers. The list may be created by one or more of manual typing in this information, uploading the information from a data file, searching a phone book maintained by the platform for the initiating party and/or accessing a database hosted on the platform of persons who have requested consideration for participation for conference calls on one or more selected topics.

The system may store the information comprising the list of invitees in a database. The duration of the period for which the information is stored may be only until the conference call is completed, or it may be longer so that should the initiating person wish to invite the same persons to a future call, he will already have a list created. The information may for example, be stored on one or more of hardware, software or in a cloud. For the purposes of the present application, unless otherwise specified, any location in which the data is stored may be referred to as a database.

The system may also allow for receipt of an identification of a desired time for a conference call. The time may for example be immediate, i.e., as soon as the request is sent to invitees, which may also be referred to as a quick launch, or at a time in the future, e.g., on the same day at 3:00 pm, the next day at a specified time or on Tuesday at a specified time.

The initiating person may send the information to the system by any means now known or that comes to be known and that a person of ordinary skill in the art recognizes as of use in connection with the present invention. For example, the initiating person may make use of an input device that comprises or is associated with a smart phone or a personal or networked computer that is configured to interact with the system. The initiating device may have a graphic user interface and/or software that permits initiation through voice activation.

After having received a list of invitees, the system transmits an electronic communication over a network to the set of one or more persons. The electronic communication comprises a notification of the proposed conference call, the desired time, and an invitation to obtain a call-in number. Optionally, the invitation may include the proposed subject of the call. A copy of the message may also be sent to the person who is initiating the call.

The electronic communication may for example be sent via a text message to a cellular telephone and/or via email to an invitee. The electronic communication may also contain a hyperlink that permits a user to accept the invitation. In some configurations, clicking on the hyperlink simultaneously indicates an acceptance of the invitation. Optionally, the electronic communication also contains a means by which to decline the invitation. However, the system may be configured such that if an invitee fails to respond, the system infers a declination of the invitation. Additionally or alternatively, if the system does not receive a response from an invitee within a specified time it may send a follow-up invitation a preset amount of time later.

If the invitation is sent to a cellular telephone, the hyperlink may be configured such that when an invitee clicks on it, communication with the system is established and the telephone number of the cellular telephone populates a field that corresponds to a request to be recognized as an authorized telephone number is populated. The invitee may be presented with the option of confirming that the automatically populated number is the telephone number that he wishes to have recognized as authorized. Thus, he may change that number to a different telephone number, e.g., if he receives the information on a cellular telephone line, but wishes to participate on a landline. Alternatively, the system can be configured to require the invitee to reenter the telephone number that he is requesting be recognized as an authorized number for each call to which he seeks to become a participant.

If the request is sent through e-mail, there may similarly be a link to an http site at which the invitee can provide information corresponding to a telephone number at which he wishes to make an authorized call. However, rather than automatically populating the field that requests identification of the telephone number, that field may be left blank until populated by the invitee. In some embodiments, if the invitee has been invited to participate before and the request is sent to an email account that is known to the system, the system may be configured to populate the telephone number field with the last number used by the invitee, which the invitee can change. Optionally, this feature can be used when the request is sent to a cellular telephone, instead of the aforementioned feature of defaulting to the number to which the request is sent may be used.

In some embodiments, the conference call is only accessible via a dial-in method. Thus, a single access number may be used without the need to manage large numbers of virtual direct inward dialings (DIDs). Alternatively or additionally the system may be configured to support direct session initiated protocol (SIP) connections through a browser for persons who wish to use a softphone on their personal computers. When using softphones, the unique identifier of the softphone would be recognized as an authorized dial-in number.

Alternatively or additionally, the system may be set up such that a person who wishes to set-up a conference call can text phone numbers to a specified SMS address. Upon receipt of the phone numbers, the system may send an invitation to participate in a conference call that is being initiated as a quick start or within a predetermined time (e.g., within 5 minutes or within 15 minutes or within 30 minutes) of the invitations being sent.

After having sent the invitations, the system will receive a user telephone number from each of one or more persons from within the set. These persons who respond as wishing to participate will form a group that corresponds to a subset of persons within the aforementioned set of persons. The subset may be coextensive with the set or smaller than the set, which would be the case if one or more persons do not accept the invitation. The set and subset may also include the initiating person.

The system transmits to each of the subset of persons electronic data that corresponds to a call-in number. The transmission to the subset of persons may occur over the same network over which the invitations were sent and to the same telephone or email account to which the invitations were sent. Thus, the call-in number is sent to an address for a recipient that the system or initiating person has designated as being a means by which to contact the invitee. However, the authorized number is not necessarily where the invitation was sent. As noted above, in an alternative embodiment, the system could send the invitation and the call-in number at the same time, while waiting for a proposed number from the invitee to be recognized as an authorized number.

At the scheduled time for the conference call, or during a period beginning a predetermined amount of time before the scheduled conference call and extending until the end of the call, an invitee may call the call-in number, and the phone number for the device from which he is calling may be subjected to a verification protocol of the present invention. The system will then permit a user to join a conference call only if the call originates from a device associated with an authorized telephone number. If the invitee calls prior to the scheduled time, he may be placed in a caller waiting room until the initiating person is ready to start the conference call.

The aforementioned methods may be used to permit voice connections between the parties, and may be established through the wired or wireless public switched telephone system (PSTN). The transfer of calling identifiers and call management information may be facilitated through data links in the wired or wireless POTS (plain old telephone service) networks.

The list of invitees may include persons who are located in diverse geographic areas. For example, they may be located in different countries. In order to prevent invitees from incurring exorbitant fees, the system may be configured such that call-in numbers are all local to the invitees, i.e., telephone numbers that correspond to the same geographic area such as a country. Thus, persons who are interested in participating in the same conference call may receive different call-in numbers, but the system would bridge the conferences associated with the two or more call-in numbers or route the callers to the same group.

In one embodiment, the subset of one or more persons comprises a first person located in a first country and a second person located in a second country. The first person receives a first call-in number and the second person receives a second call in number, wherein the first call-in number and the second call-in number are not the same numbers. The first call-in number may represent an intra-national call for the first person, and the second call-in number may represent an intra-national call for the second person. The system may further comprise joining together all persons who have dialed either the first call-in number or the second call-in number and were invited to participate in the same group.

Conference calls may have large numbers of persons participating e.g., 2-2000, 10-1000, or 50-500. However, it may be of interest to some persons to know which participants are physically closest to them. In some embodiments, the volume of a person who is speaking that is heard by a person who is listening is dependent upon the physical proximity of the person who is speaking to the person who is listening. Thus, by using one of the methods described below, the system can determine each person's geographic location and upon detection of speech coming from one person, amplify or decrease the volume for each other person based on their relative physical proximity. According to these methods each person can be ranked by distance to each other person and the amount of amplification or lessening of volume can be different for every person relative to each listener, or there can be tiers of proximity in which all persons who are for example within 10 miles of another person are heard at one volume level, all persons between 10 and 50 miles apart are heard at a second volume level that is lower than the first and all persons more than 50 miles away from each other are heard at a third and lowest volume level.

As persons who participate in conference calls recognize, there are times when it is preferable not to have one's identity known; however, it may be preferable to have people be able to recognize that two or more points were made by the same person and/or to have the ability to reach out at a later date to a person who made a particular contribution to a conversation. Accordingly, in some embodiments, each person may be identified by a “handle.” This handle may be “a privacy protected handle.” A privacy protected handle is a handle that does not provide information that can be used by a person who only has access to it to identify the owner through publicly available databases. Thus, preferably it is not a person's legal name, birth date, social security number, rare physical attribute, etc. For example, it may comprise one or more of a nickname, an alphabetic code, a numeric code or an alphanumeric code. In some embodiments, the handle is generated by the system and is random or is generated by encrypting the authorized number. In other embodiments, it is generated by the person to whom it will apply.

Invitees may participate as members or non-members of the system. When participating as a member, an invitee (or an initiating person) may create a user profile that allows him to initiate calls and/or to obtain increased benefits. In various embodiments, the benefits of membership include one or more of: (1) creating a user phone book; (2) creating a profile of descriptive or identifying information; (3) initiating a search function: (4) keeping a journal; and (5) accessing and managing a wallet.

A “user phone book” is a set of data in which a user can keep information pertaining to other persons with whom he has already had contact or with whom he wishes to have contact. A user may populate the phone book with data that he provides, including one or more of a persons' name, telephone number, e-mail address, age, gender, political affiliation, religious affiliation, notes, ratings, etc. The system may design a user phone book such that only a user (and optionally a system administrator) may have access to his full phone book. Thus, each of a user's contacts would be prohibited from seeing all of the other contacts. Furthermore, after an invitee joins a conference call and becomes a participant, he may be presented with the option of adding one or more other participant to his phone book. However, the system may be set up such that by default, only a participant's handle is imported into someone else's phone book. If the person whose phone book it is wishes to contact that person in the future, he would select the handle, and ask the system to send a friend request or an invitation to a conference call. Thus, the initiating party would be prohibited from contacting the person directly.

The phone book may also be configured to associate groupings with entries. Thus, a person may denote any one or more persons within his phone book as being part of one more groups. As persons of ordinary skill in the art will readily see, by doing this a person can streamline the process for inviting persons to conference calls in the future. He can select his created group, and the system can send an invitation to all members to whom it applies.

A “profile” is information about a user. The system may be designed to have categories of profiles such as personal profile, work profile, freelance profile and free advice profile. A person who is a member of the system may be presented with the opportunity to populate fields with data that is relevant to each type of profile. A personal profile may include one or more if not all of a person's name, age, physical characteristics, address, education, health status and number of children. A work profile may contain information that includes one or more of certifications, licenses, job experience, past employers' names, current employer's name, and work contact information. A freelance profile may include information that describes a person's expertise or skills for which he would be willing to work outside of his current employment. A person's free advice profile might include information that a person is willing to share free of charge, e.g., history battling a disease or vacation experiences. As noted above, a user may control what about his profile is accessible to other members. For example, as a default only a user's handle may be accessible.

If an invitee is not already a member, he may upon receipt of an invitation be invited to become a member and to complete a user profile. However, the system may be configured to allow him to participate in a conference call without becoming a member. In some embodiments, if he elects not to become a member, he may be denied the ability to see others' handles and to send friend requests to any user's handle.

The “search” functionality permits a user to obtain information maintained by the system that members have provided as being authorized as searchable. For example, someone seeking to initiate a conversation about nuclear physics may search in all types of profiles or in the work profile only for persons who have designated themselves as nuclear physicists or having an interest in nuclear physics. The searching capabilities may be through Boolean search structures, natural language, and/or preformed group lists. The system may configure this feature such that the results display only a searched person's handle or profile information that the searched person deems acceptable for displaying prior to providing explicit authorization to disclose more information.

The “journal feature” enables a user to record spoken, video or typed words into a database. The user may post this information to any or all profiles, and depending on the degree of privacy that the user selects, one, a plurality or all other members may have access to the journal.

The “wallet” feature enables a user to provide payments. The wallet may be or be able to be coupled to a portal that allows for the electronic transfer of funds. Optionally, the wallet may store data that corresponds to one or more credit cards, debit cards, bank cards or bank accounts. If this information is stored within the wallet, preferably the wallet contains sufficient security features.

The person who leads a conference call may be referred to as a phone caster, and he may have the ability to initiate and to terminate the conference call. The system may be configured to allow only members to be phone casters or it may be configured to allow non-members to be phone casters. By way of a non-limiting example, the phone caster may be a professor who is providing a new or review lesson to a class. Alternatively, it may be a person who in other forums has served as a blogger and is seeking to move into voice media.

A phone caster can select himself to be the initiator of conference call, or the system can have a minimum set of requirements before a person obtains the status of a phone caster. For example, the phone caster may be required to have a rating above a predefined level, wherein the rating corresponds to one or more of the phone caster's knowledge, duration of experience in the field and likeability. The rating can be compiled by asking persons who have either had conversations with the phone caster or listened to him in a conference call to rate his abilities on for example a scale of 1 to 5 or 1 to 10 or 1 to 100 or based on a number of stars. The standard may also require that the phone caster first establish an invitee list of a minimum size, e.g., greater than 500 or greater than 1000 or that he demonstrate a threshold number of committed listeners.

As persons of ordinary skill in the art will readily recognize, an organization may use this technology to test out talk show hosts. An organization could set up different individuals as phone casters and allow listeners to provide feedback. Because the system can be configured to track who calls in as a listener, the organization can determine how many people are listening, what percentage of people are providing feedback and the nature of the feedback. This will allow the organization to determine the value of the data that it collects and the phone caster's potential to generate a loyal following.

Optionally, the system may be configured to record and/or to transcribe the conference call. Recordings and transcriptions may for example be stored digitally and either for a fee or for free be accessible to one or more of the initiating person, member participants, all participants or the public.

According to a second embodiment, the present invention provides a method for establishing a telephone connection between or among a plurality persons who are interested in a topic. The method comprises: (a) receiving a selection of a topic of conversation from a person; (b) transmitting to a set of one or more persons an electronic communication over a network, wherein the electronic communication comprises a notification of a conference call, information corresponding to the topic, a desired time, and an invitation to obtain a call-in telephone number; (c) receiving an acceptance of the invitation from a subset of persons from within the set and a proposed telephone number from which to join the conference call; (d) providing each person within the subset, the call-in telephone number; and (e) permitting a person to join the conference call if the person calls from a proposed telephone number.

This embodiment can readily be seen as an efficient means by which to enable an initiating person to set-up topic based conference calls. In some embodiments, the platform on which the topic talks are hosted enables invitees to participate as members or non-members. In some embodiments, members and non-members have the same ability to participate in the conversation, whereas in other embodiments, only members are able to be heard. Furthermore, in some embodiments, only members have the ability to see the handles of persons who are participating. Additionally, with respect to non-members the system can be configured to store non-member information that originates from the same authorized telephone numbers and/or invitation numbers and emails. In these instances, if the non-member later wishes to become a member, the system can pull-up data that relates to that person. Alternatively, the system can be configured not to save data of a non-member or to give the non-member the option of whether his data should be saved.

The system itself may contain a list of topics that is for example accessible to a person seeking to initiate a call through a drop-down menu. Optionally, next to the topic is an indication of the number of persons who have previously expressed interest in participating in a conference call on the topic. Upon selecting the topic and providing a proposed time for the call, the system may cause invitations to participate to be sent to all persons within the group.

In addition to occurring through user initiated conference calls, topic talks may also be automatically initiated by the system itself at regular intervals or by monitoring and analyzing trending topics. When a trending topic has reached a critical mass, the system may invite persons to participate in a conference call about the topic. The monitoring and analyzing can be accomplished through the use of algorithms and/or artificial intelligence technologies.

According to a third embodiment, the present invention provides a method for establishing a telephone connection between or among a plurality of persons comprising: (a) receiving a selection of a topic of conversation from a person; (b) transmitting to a plurality of persons an electronic communication over a network, wherein the electronic communication comprises a notification of a conference call, a desired time, information corresponding to the topic and an invitation to obtain a call-in telephone number; (c) receiving an acceptance of the invitation from a subset of persons from within the set and dividing the subset into two or more subgroups, comprising a first subgroup and a second subgroup, wherein each subgroup comprises at least two members and providing members of the first subgroup with a first call-in number and members of the second subgroup with a second call-in number, wherein the first call-in number and the second call-in number are not the same; (d) within each subgroup, identifying each person to each other person by a privacy protected handle; and (e) providing each person with a ratings option, wherein the ratings option permits each person to provide feedback as to the quality of each other person on a conference call. The data that is collected may be accessible to members as they seek to select other persons with whom to communicate.

In one embodiment each subgroup is limited by size to a predetermined number. For example each subgroup may consists of two to ten persons or exactly two, three, four, five, six, seven, eight, nine or ten persons. The predetermined number may, for example, be set by a system administrator. Division into subgroups may be random or it may be done by applying an algorithm. The algorithm may comprise applying one more weighted or unweighted criteria selected from the group consisting of location of the caller, age of the caller, religion of the call, political affiliation of the caller, gender of the caller, and education level of the caller. Each of these parameters may be provided by the caller at the time of the call or optionally it may become or already be part of the caller's profile, which may have been input when the caller became a member or at another time.

Although a user may manually supply the information of his location, this information may alternatively be obtained by one or more of collection of smart phone data, triangulation of a cellular telephone, global positions system (GPS) coordinates, global system for mobile communications (GSM) or any of a number of known technologies for identifying data when a call originates from a landline.

The system may also be configured to permit a participant to a request to end a conversation with a first person and to commence a conversation with a second person who expressed interest in conversing on a topic. Thus by way of a non-limiting example, if ten people respond that they want to participate in conference calls, the system may notify them that they will be paired off in groups of two and each person will be able to have up to nine different calls. The participants of each call could decide the length of each call or the system could define the length under parameters akin to speed-dating e.g., each call is three to five minutes in length and then will terminate.

During a conversation of any of the embodiments of the present invention, the system may be configured to display the handle of a participant who is speaking, and optionally all other participants who are listening. By displaying a handle and only a handle, the present invention balances the desire for participants to control the degree of privacy that they retain with respect to their confidential information while still allowing other participants the ability to associate comments by the same speaker that are made at different times, with that speaker. Accordingly, in some embodiments, the present invention further comprises transmitting a friend request received from a first person to a second person and if accepted by the second person, receiving notice from the second person a level of detail about the second person to which the first person may have access. If a friend accepts a request, then the system may treat the inviting person and invitee as a group of two persons. In order for a handle to be displayed to a participant, the participant will need to be using a device such as a smart phone or a PC that is configured to display the information.

According to another embodiment, the present invention provides a method for permitting a person to solicit offers from merchants. This method comprises receiving electronic data over a network that corresponds to a request for a good or a service from a person who has access to a platform. The request comprises at least one of an item name, an item description, a time, a location, a number of persons and a price or price range. For example the request may recite: a dinner reservation between 6:30 and 7:30 pm for people in Mid-town Manhattan for Vietnamese food, looking to spend under $250.

The system may receive from the requesting person, an identification of a group of one or more merchants. The identification of each merchant may comprises a merchant name and/or description of a type of goods or service offered by the merchant. The system then transmits the request and a privacy protected handle to all members of the group. One or more of the members of the groups may transmit a response, and the system receives the response and transmits it to the requester. The response may contain an option for the person to enter into discussions with the merchant or it may contain in indication that it can accommodate the request.

This embodiment enables a person to search for a product or a service, optionally within a given locale. The locale may be defined as an objective locale, e.g., Times Square, New York, or it may be defined as a relative locale, i.e., a location within specific distance from the user at the time of placing the request, e.g., within 5 miles. In the latter case, the system may use one of the technologies described above for identifying a location of a user. The system may also link the request to the geographic information of merchants. Optionally, this information is presented to the user in the form a list and/or a map.

Because the information is sent simultaneously to merchants, the burden is shifted from a consumer to a merchant to obtain the best deal. The merchant will have the option to respond to a request or to ignore it. If the merchant responds, it can counter-offer and negotiations can ensue. At the will of the consumer, the consumer's identity can remain hidden until he wishes to reveal it, e.g., at the time of making a reservation for a restaurant or not until the time of showing up at the restaurant for a meal. As used herein a merchant is a person or business who offers goods and/or services for a price.

A person from whom the request is made may have a phone book stored in a database and the group of merchants is identified in the database. Alternatively or additionally, the system may offer predetermined groups or filter by food, location and/or price. The person from whom a request is made may also have the option of receiving electronic messages from the merchant in the future. These messages may include promotions or notices of discounts and the person need not disclose his identity to the merchant to receive them.

The person may also be able to access an electronic wallet in order to transact business with the merchant. The electronic wallet may be able to send payments through the system to the merchant or to a third party such as PayPal if an authorized account exists.

The system may also be configured such that if a person selects a merchant, that merchant may automatically become an entry the person's phone book. Alternatively, the user may be given the option of having the merchant become an entry in the user's phone book.

As noted above, the various methods described herein may be stored in the form of a non-transitory computer readable medium. This medium may be capable of storing computer readable instructions that, when provided to a processor of an apparatus, cause the apparatus to perform the steps of those methods. In some embodiments, a “non-transitory tangible computer readable storage medium” may include hardware, software or a combination of the two on which one may store a set of instructions that may be used to direct a computer to perform a set of steps. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. In some embodiments the instructions are stored on a medium that can instruct a computer having one or more of the following hardware components: memory, storage, an input device, an output device, a graphic user interface, a communications portal and a central processing unit.

A processor is the part of a computer's central processing unit that can execute instructions and manipulate data. The processor is configured to access data in database, to carry out protocols contained in a non-transitory tangible computer readable storage medium, and to transmit and to receive signals from other electronic devices.

A number of embodiments of the present invention also provide an apparatus comprising at least one processor and memory operably coupled to the at least one processor and storing executable instructions the when executed cause the apparatus to perform any of the methods described herein including but not limited to: (a) receiving data identifying one or more invitees to a conference all; (b) sending an electronic communication to the one more invitees, wherein the electronic communication comprises a proposed time, a subject of a conference call and a means by which to provide a proposed telephone number associated with a device from which an invitee will join the conference call; (c) receiving the proposed telephone number; (d) transmitting a call-in number to each invitee who has supplied a proposed telephone number; (e) receiving a telephone call at the call-in number; and (f) if the telephone call originates from a device that is associated with a proposed telephone number, then connecting the caller to the conference call. Any one or more if not all of the aforementioned steps may be automated.

Additionally, the aforementioned apparatus may be part of or operably coupled to a telephone system. The telephone system may comprise a plurality of telephone communication devices that may connect to a network and a platform through which the plurality of telephone devices may access the protocols of the methods of the present invention and receive and/or supply data in order to participate in the methods. Further each of the telephone communication devices may possess input functionalities to enable a user to dial into a network or conference call, to convert speech into a form capable of transmission and to receive data that can be converted into audio information. The various components may also comprise the necessary portals to enable communication for the intended purposes of the present invention.

The system and platforms should be selected to be of sufficient connectivity, power and size for the desired application. For example, there may be one or a plurality of services that each have connectivity of 1-2 Gbps, power of a 120 v 30 amp circuit and a 1-42 U rack. Specific examples of hardware that may be included in the system include but are not limited to:

Dell PowerConnect 5424 switch (1U);

Dell PowerEdge R410 (1-U, 8-Core, 4-HD's)

Processors: Intel Xeon E5530 (4 Core, 2.4 GHz) Qty. 2

Memory: 64 GB (1333 MHz) 8×8 GB

Hard Drives: 200 GB, SSD, 2.5″ Hot Plug Qty. 2
1TB, 7.2K RPM SATA, 3.5″ Hot Plug Qty. 2

Dell PowerEdge 2970 (2-U, 12-Core, 6-HD's)

Processors: AMD Opteron 2427 (6 Core, 2.2 GHz) Qty. 2

Memory: 32 GB (1033 MHz) 8×4 GB

Hard Drives: 146 GB, 15k RPM SAS, 3.5″ Hot Plug Qty. 3
1TB, 7.2K RPM SATA, 3.5″ Hot Plug Qty. 3

Dell PowerEdge R415 (1-U, 12-Core, 4-HD's)

Processors: AMD Opteron 4180 (6 Core, 2.2 GHz) Qty. 2

Memory: 32 GB (1333 MHz) 8×4 GB

Hard Drives: 500 GB, 7.2K RPM SATA, 3.5″ Hot Plug Qty. 2
2TB, 7.2K RPM SATA, 3.5″ Hot Plug Qty. 2

Dell PowerEdge R815 (2-U, 32-Core, 6-HD's)

Processors: AMD Opteron 6136 (8 Core, 2.4 GHz) Qty. 4

Memory: 128 GB (1333 MHz) 32×4 GB

Hard Drives: 146 GB, 15K RPM SCSI, 3.5″ Hot Plug Qty. 3
2TB, 7.2K RPM SATA, 3.5″ Hot Plug Qty. 3
   The aforementioned hardware is intended to be illustrative of the type of hardware that may be used in connection with the present invention. It is not intended to limit the scope of the claims.

In some embodiments, the database engine uses JDBC/Postgresql, and the system is capable of producing statements and queuing them without occupying a connection pointer. When a statement is ready to be processed a connection is grabbed from a pool of for example 100, and the pointer is occupied and executed. If the statement requires a result set, the pool item remains “locked” until the result set is returned. This type of functionality prevents lag and connection limit errors when dealing with the database. In some embodiments, no more than 100 file pointers are ever in use at a single moment. The system may also employ a database queuing manager, which ensures that long non-responsive requests don't use up pointers for other users.

In some embodiments, the custom proxy server has its own memcached (a distributed memory object caching system), which manages where to direct calls, based on caller id and access number. The unique part about this system is the fact that it requires no database interaction or api interaction. The call routing rules are set up before the caller even connects to the access number. When a user calls in, there is a p_route_{—}+1xxxxxxxxxx record that is searched where the +1xxx number is the caller id of the caller. This record contains a sip url to a voice server that will handle the call whether that server is a conference server, chat server, or other product.

The architecture of system may be selected to perform a large number of actions at the same time, e.g., directing at least 400 request per second in a proxy application; handling at least 400 simultaneous inbound connections in a group call application; handling at least 500 simultaneous inbound connections in a mobile cast application; handling at least 1000 simultaneous inbound connections in a topic talk application; delivering at least 500 simultaneous audio advertisements in an ad server application; and delivering at least 500 simultaneous invalid replies in an invalid reply application.

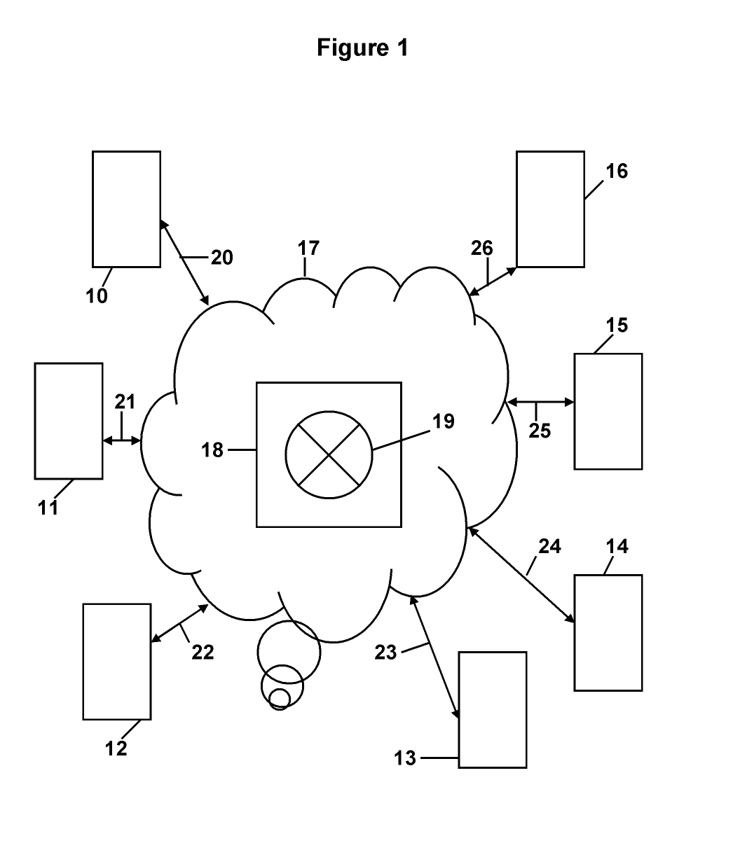

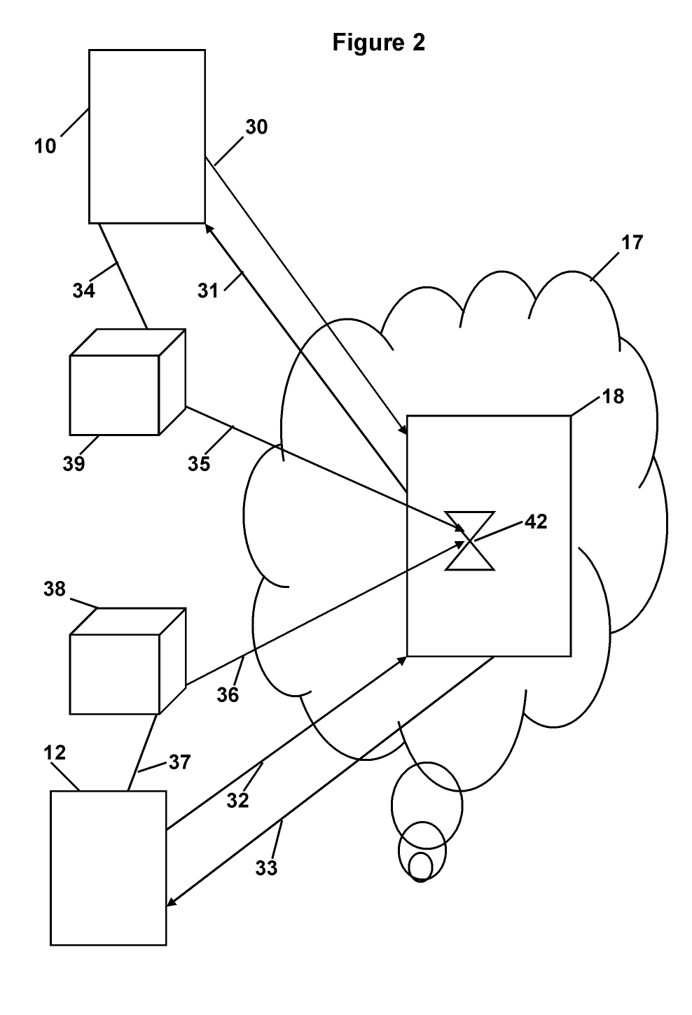

Various embodiments of the present invention may be further understood by reference to the accompanying figures. In FIG. 1 and FIG. 2, there are shown telephonic communication and/or computing devices 10, 11, 12, 13, 14, 15, and 16, in which any number of devices can be included. Any limitation on the actual number of such devices that can be connected is established by the communication carrier subject to capacity limitations for their network(s) and not the present invention. These devices may or may not be internet accessible; but preferably they support all applicable data messaging standards and are capable of being addressed or identified by a unique user or equipment identification number. By way of non-limiting examples, the phones may be smart phones that operate with html 5 or higher or feature phones that run off of JAVA.

Each of the devices 10, 11, 12, 13, 14, 15, and 16, is attached via a wire-line and/or wireless telecommunications 20, 21, 22, 23, 24, 25 and 26 connection to a network such as the world-wide-web (internet), 17, for routing to a media link application platform 18. The media link application platform may be a data processing system comprising servers, switches, databases and storage elements. Each of the elements of the media link application is operably coupled to one or more other elements of the media platform. An element is operably coupled to another element when the two elements are configured to communicate with each other or one is able to initiate a protocol that accesses the other element. When the methods are stored in computer program products, they may be in the form of protocols.

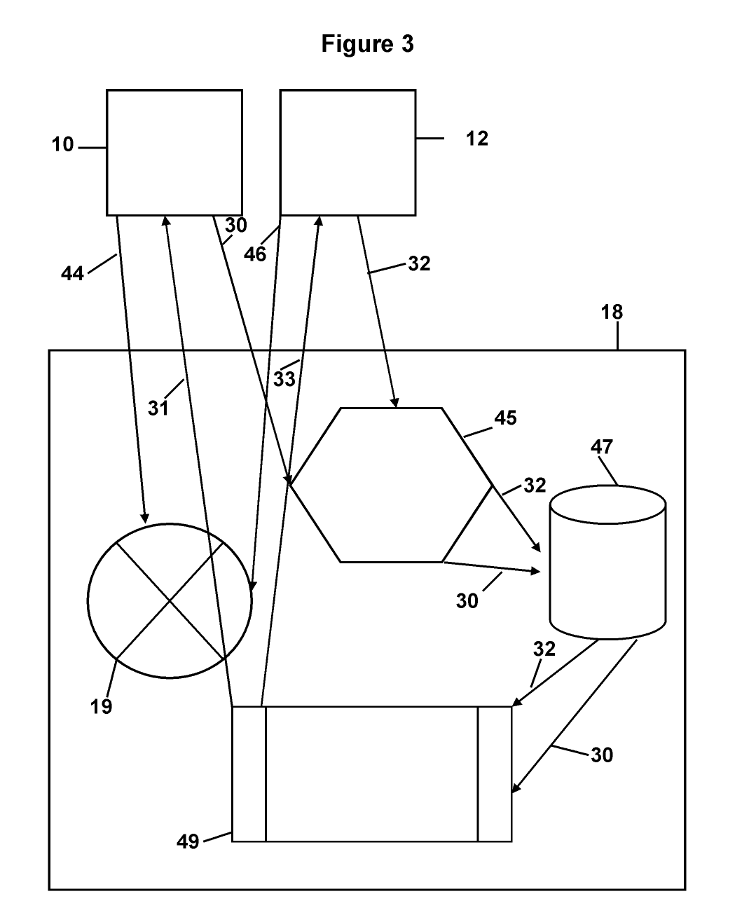

In further detail, still referring to FIG. 1 and FIG. 2, the ability to connect a duality or multiplicity of calling parties together in a conference call 19, without passwords and users names is facilitated by the communication device's ability to provide unique identifiers that can be authenticated by the platform that is described in FIG. 3. Throughout this specification the unique identifier is often described a telephone number; however, it is within the scope of the present invention for other unique identifiers to be used. Thus, compliant devices, such as mobile wireless phones with microprocessors; Voice over Internet Protocol (VoIP) phones; and any other computer processing units with communication capabilities that can be uniquely identified through a serial number or other electronic signature or by an ANI as described above may be used.

Callers who have compliant devices can make requests to the platform for access to media link services and be authenticated based upon the information they provide when registering for the service. Their request for access may include information on the nature or topic of the call or chat and any additional information on the called party, location or time for the call they desire. Thus, these callers may access the necessary interfaces to initiate conference calls.

The connection details of the invention as shown in FIG. 1 and FIG. 2 are based on the ability of each device to establish its identity with the application platform 18 via a data connection that can be made through either a wireless or wire-line network interface. The set up of the voice communication channel can be made on an ad hoc basis through a chat or instant messaging connection feature of the application platform (i.e. for a social networking session) or through a pre-determined conference arrangement that allows for multiple, pre-arranged chat or instant messaging connections.

For the ad hoc chat connection feature, a user with a compliant device can log into the application and send a request to be connected instantly with another party that would also like to be connected instantly with another party for the purpose of talking or sharing information on a specific subject matter or topic of conversation. This connection would occur within a given chat room or logical space or physical site (i.e. community of interest or chat room) through the media link application. This logical space is defined as a single or multiplicity of common interest areas or chat rooms; while the physical site is associated with an identification codes (such as direct inward dialing or DID numbers) and may be made available to callers through the following means: (i) either the next available caller that desires to be connected with another caller on this specific topic; (ii) the closest geographically available recipient to the originating caller; or (iii) to the party that has the profile, usage patterns, or demographic/psychographic profile desired by the other party. These connection may be limited to two persons at a time or be set up under parameters that allow for larger groupings.

In various embodiments, the system comprises an algorithm that upon activation by a user or as a default algorithm that is automatically activated effectuates one of the aforementioned three options. In some embodiments, this algorithm is stored as a computer program product in a non-transitory medium.

For a conference, voice feature duplicity or multiplicity of parties will be connected via a voice link application. The implementation of this feature requires the originating party to invite the called party through a messaging or other suitable arrangement known to the media-link application, such that their time for the call can be arranged at an acceptable time under acceptable conditions. When the parties have previously registered to use this service, no access lines or numbers are required to be dedicated and the use of access codes or user identification is not required because the platform (FIG. 3, 18) communicates the necessary call set-up and routing information to the users through their compliant devices as described above.

Although many of the embodiments above have been described with respect to an invitation to join a group, the system can also be configured to allow members to request to join groups that function as voice chat rooms. Referring now to FIG. 3, it is shown that the request to enter a chat session or engage in a conference call is established via a data link to the application that would specify which chat room or social community site the originating party wishes to enter and be connected. The manner and location of the connection of chat and/or conference callers is based on either a unique or common identifier that is sent via a data link connection (FIG. 3 items 31 and 33) or the totality of call location identifiers can be automatically downloaded on the telephonic and/or computing devices upon the user registering into the application or at any time concurrent with the selection of the chat room or conference calling party(s). The data store 47 maintains a current listing of all chat rooms (common interest sites) and users and upon request from the originating device(s) sends a DID or other calling identification information back to the device to link the callers. In the case of a chat, the originating caller is connected immediately to the next available party that meets the system's or their pre-defined requirements; while in the case of the conference the originator initializes a message that is known to the data store by which a request is sent to be connected with a designated party.

In more detail and referring to FIG. 2, the user device has two forms of communication—first, the data connection that is established via telephony and/or session internet protocol links that can be used to request service as well as receive calling direction to the specific location identifier for the chat or conference and second a voice over internet protocol (VoIP) connection to complete the chat or conference link to the intended calling party using the Public Switched Telephone System (PSTN—wired or wireless). Devices 10 and 12 are in communication with platform 18 through the internet 17.

In further detail and referring to FIG. 2, the software algorithms in 38 and 39, which are part of the front end call process, identifies and authenticates the callers' requests for service 30 and 32 by matching their calling request; user profile; rights/restrictions and preferences against the information contained in database 47. The front end processor can constantly monitor requests for any number of simultaneous users that are requesting either to enter into defined chat room or to be connected with designated call recipients. Within FIG. 2 in this embodiment the database stores identification information for the call and transfers such data to the call processor which sends call set-up information (DID numbers) to the telephonic devices 31 and 33 in any of the following ways: (i) upon the originating party's request all the location identifiers for each unique chat room or topical site can be furnished by the database and returned to the originating party telephonic device via the call processing server; and/or (ii) at each instance in which the originating party requests an initial or new chat room or topical site.

Also show in FIG. 2 is where individuals who are unknown to each other dial into the platform for example to participate in a topic talk 42. Thus, these individuals may be looking to participate in a discussion of a specific topic. In addition to the system being able to align topics 38 and 39, through connection to the platform 35 and 36 and to the users 34 and 37 the system may be configured tag a unique code based on an algorithm to pair callers based on their preferences. This unique code will follow a caller for the duration of his dial in. By way of a non-limiting example, at any one time for any one topic, there may be thousands of people dialing into a single topic. However, in some applications, regardless of the number of callers, the system places each caller in a one on one private conversation with another caller. If at any one time there are an odd number of callers, the last caller may be presented with music until another caller enters or becomes available, which may for example occur when another caller drops off.

Each caller is presented to each other caller anonymously; however, the system keeps track of the identity of each caller. By use of a call log that is maintained by the system, one caller may use the system to reach out to another caller for a future conversation. If the second caller agrees, the two callers can become a “contact level” of friends. This level of friendship allows messaging within the platform of the system. Optionally, users can authorize a closer level of connection by moving from a contact level to a “friend level,” which would allow each user to see additional information about each other. Thus, each level reflects a user selected privacy level. In addition to becoming friends, each user can rate a conversation, report the caller and add notes to a call log. The call log may also be used store the topic, date time and nicknames. This additional information may be particularly helpful if a user speaks with a plurality of other users in the same dial-in session.

The connections details as shown in FIG. 3 are that once the front end processor 45 and database validation 47 are completed, the call processing software 49 will send call/link set-up and call completion instructions associated with the DID information to the users devices to establish the connection 19 in the desired chat, group call or social network space. Further, these instructions are transmitted back to the device user, as shown in FIG. 3 through links 31 and 33 to devices, 10 and 12, respectively in this implementation; either at call initiation concurrent with the initial request or at any time during the session. The application platform can similarly establish simultaneous connections for other users and/or for other chat sessions with the only limitation being those imposed by the network carrier to avoid blocking situations that could overload their network. In further detail and referring to FIG. 3, based upon the call routing information (DID trunks, timing of call and privileges) is transferred to the compliant devices, each user will receive a link on the device display and can initiate the call (chat or conference) via wireless or wired telephone links 44, and 46 that is routed through the mobile or fixed telephone network. Thus, FIG. 3 details the flow of calls from two users 10 and 12 as follows: (1) user 1 from 10 (device)→30 (wired or wireless connection)→45 (database)→30 (wired or wireless connection)→47 (database validation)→30 (wired or wireless connection)→49 (call processing software)→31 (wired or wireless connection)→10 (device)→44 (wired or wireless connection)→19 (call group); and user 2 from 12 (device)→32 (wired or wireless connection)→45 (database)→32 (wired or wireless connection)→47 (database validation)→32 (wired or wireless connection)→49 (call processing software)→33 (wired or wireless connection)→12 (device)→46 (wired or wireless connection)→19 (call group).

As noted above, some of the technologies of present invention allow one user to be connected to another user or other users without needing to pre-arrange the call and without needing to exchange/remember and input complicated access codes/usernames; while using high quality PSTN calling connections. This manner of implementing a voice call doesn't rely upon: (i) dedicated or private link(s) that must be maintained throughout the call; or (2) pre-exchanging access codes and user id's prior to the start of the call

The advantage of various embodiments of the present invention include that they allow for spontaneous, instant communications between parties that have not had the opportunity to exchange telephony contact information prior to the start of the call. Further, they allow multiple calls to be carried over the same broadband communications link, thereby saving considerable cost relative to expensive individual channels or phone numbers.

While the foregoing written description of the invention enables one of ordinary skill to make and to use what is considered presently to be the best mode thereof, those of ordinary skill will understand and appreciate the existence of variations, combinations, and equivalents of the specific embodiments, methods, and examples herein. The invention should therefore not be limited by the above described embodiments. Furthermore, unless explicitly stated or implicit from context, the features of any one embodiment may be used in connection with any other embodiment described herein.

### EXAMPLES

### Example 1

### Incoming Call Handling

A call to the system may be generated automatically by an application running on the caller's method of access. The application has access to the user's settings, so it is aware of the user's status in regard to the service that he wants to use. For example an user can be a simple participant in a group call, or can be a host in a mobile cast

A smartphone application also collects the user identity and privacy information. All of this data is communicated via an API request (REST over http) to the platform. The platform verifies the user identity, his credentials for the service, and prepares to receive a call. It then communicates back to the mobile application the phone number (DID) that needs to be called.

Because the called numbers are typically transparent for the users, the DIDs used by the service are not tied permanently to any specific service (group call, topic talk, mobile cast etc.) and not even to a specific type of service. For example, a topic talk channel regarding the NFL Super Bowl can be started at 7 am on a Sunday morning, and turned off late Tuesday night and a Topic for NBA can be started on Friday night and last until Sunday night. When the request for either topic is received from a user, the API called searches the database and assigns any available DID for the service type “topic talk.” Users selecting different topics can still be given identical DID's at the same time. The platform will know to send each user to their selected rooms when they dial into the platform using the DID provided.

The service descriptor KVP has the key [p_service_did] and contains at a minimum the following fields:

service—service type: group call, topic talk, mobile cast

name—service name

prompts—list of personalized prompts for the service (name-value pairs)

sarah—list of variables that will have to be set for sarah (name-value pairs);

Common values for the sarah session are:

membership—minimal membership level required to get access to the service; currently defined values: any |registered| premium

rec—if the value is “r,” the chats/group calls/shows are recorded

maxcall—maximum duration, in seconds, for a call

The meaning of the name-value pairs is service dependent, and is explained below in the paragraphs describing the services.

The API called by the smartphone app also creates a “call stub” record in a cache store. The application will later use the data in the call stub as a reference to the user's details and preferences.

The call stub is a KVP called [pxx_servicename_call_ani] where pxx is a 3-letter service type identifier (service types are pch for topic talk, pxx for group call and mobile cast) servicename is the actual name of the service (nfl_superbowl in example above).

The call stub will initially contain the following fields:

pin—a 4-digit number used to identify the caller, if extra identity checks are necessary/requested

access_code—for private group calls, the caller will be asked to dial in the access code, in order to get connected to the audio stream; this is a single use random code that will also be part of the API response, and will be displayed on the caller's phone.

An “add” operation may be used to create this key (such that it would fail if the key already exists), and a timeout value of a few minutes. Based on the response received from the API, the application running on the user's smartphone initiates a call to the DID contained in the response. The application makes every effort to have the outbound call carry the user's Caller ID (phone number). Providing the Caller ID accelerates the user identification process executed by the application.

On the application side, the call received from the user gets distributed to the right service based on the information obtained from when the user initiated the service. Upon answering, a call gets played a welcome prompt. Services have a default welcome prompt, and each service can have a personalized welcome prompt. In most cases, according to the scenario above, the application will receive the Caller's ANI. If the ANI is not present, the application asks the user to enter it.

At this point, the application will try to obtain user information, related to the service that has been called. Typically the user information can be found in the call stub (KVP) with the key [pxx_servicename_call_ani], and the content layout as described above—this is because the API created it. If the key is missing, an attempt to (re)create it is made, by calling a REST API.

The [pxx_servicename_call_ani] call stub is transformed in a call record, by populating it with the following additional fields:

t0—timestamp when the call started

channel—channel id assigned by sarah

callid—unique id of the call, composed of:
first character of the site name
first character of the node name—a timestamp identification, like YYMMMDDHHNNSS
2 random characters

The call id also represents this call's log filename (search for it in the corresponding subdirectory made up like MMDD-HH).

A “replace” operation may be used to adjust the value of this key (such that it would fail if the key doesn't exists), and a timeout value equal to the maximum call length. —

The result from a user information request may be any of:
granting the user access based on the ANI;
a need to authenticate the user with a PIN before granting access;
finding out that the user has been blacklisted for that service; or
rejecting the user because the ANI is not registered in the database.

This application gives the user three chances to enter the correct PIN, before hanging up the call. After three calls in which the user wasted all three attempts to get identified, all within a 24 hour interval, the system considers the caller as a brute-force hacker and places the ANI on a global blacklist. If the service requires an access code, the caller is asked to enter it. Similar to the above behavior, three failures mean hang-up, three calls with three failures each during that same 24 hour interval mean blacklist. At this point the application is ready to proceed with executing one of the services described below.

### Example 2

### Group Call Rooms

Service names are, in the group call paradigm, group call rooms, or simply “rooms.” A group call room is a virtual place where a group call gets created either ad-hoc, at a pre-scheduled time or is permanent. The room has an owner, is administered by one or more moderators, and typically all people invited have the right to talk.

Moderator rights are managed by the owner. A moderator may be the only person in a group call that has the option to temporarily mute (then unmute) all other participants. Group call access is restricted by invitation only; for an added level of security, the participants can be required to enter an access code. While in the group call, any invited participants can press the * (star) key to cast a vote for the group call room. There is only one vote per user. Group call rooms ratings and audiences can be made public, and the system may push audio commercials, played to all the participants. The commercials may be automatically pushed at preset intervals of time.

Depending on the group call room settings, a moderator may be able to open ad-hoc a group call, or terminate a group call by pressing 9 (optionally, he will be asked to confirm). The system may also offer the audio feed of the group call as a public or private accessible audio stream, in listen only mode, with a computer audio player or DID. Additionally, the system may play the recording of the last show (session) to the caller, if he calls into the group call room at a time a group call is not scheduled. Still further, for scheduled group calls, the system may offer a “capturing menu” for the participants who call in a few minutes before the group call is supposed to start.

Because access is restricted by the invitation, it is virtually impossible that a random caller, who is also a member, accidentally dials the specific DID given, at the specific date and time, and has the same caller information in their settings or entered into an Invite, while the group call is on, and gains un-intended access to the group call room.

### Example 3

### Call Handling

Calls may be handled by assigning and tracking variables. The corresponding [p_service_did] section features, under the sarah variables section, in addition to the standard variables may include:

offtime—an audio file that is played to regular participants, if they call into a group call when the group call is not ongoing; usually this is the recording of the last group call. If there is no value assigned, the prospective participant's call is rejected.

moderators—ANIs (user id's) of the moderators, comma-separated

confmaxduration—maximum duration of a group call, in seconds

In addition to the fields described in the common call handling section, the call record named [pxx_room_call_ani] is expected to have, before the call is received:

role—whether the user is a moderator or a invited participant

Also, once the call is answered, the following fields are created:

t0—timestamp when the call started

channel—channel id assigned by sarah

callid—unique id of the call, composed of:
first character of the site name
first character of the node name
a timestamp identification, like YYMMDDHHNNSS
2 random characters

The call id also represents this call's log filename (search for it in the corresponding subdirectory made up like MMDD-HH)

Starred—indicator of whether the caller pressed the star key to rate the group call (whatever other details)

A “replace” operation to adjust the value of this key (such that it would fail if the key doesn't exists), and a timeout value equal to the maximum call length. As soon as the authentication stages are passed, the service KVP called [p_service_did] is updated to include the following parameters:

Group call—the internal sarah group call id; this is a 5-digit random number, between 10000 and 99999, chosen at the time the KVP is created; it is also appended in a KVP called [p_GroupCalls] (comma-separated values), so the system avoids generating duplicate id's. The group call number is removed from the live group calls list once the show is over.

t0—time when group call got started

moderators—comma-separated list of keys of the moderators' call records who are present in the group call

participants—comma-separated list of participants' call record keys; this list can take duplicates (e.g. for when a participant hangs up and calls again)

muted—0 in normal mode (everybody can talk and be heard), 1 if a moderator has all participants muted

no_callers—timestamp of the first time the group call was detected as having no callers connected; this will start a time bomb that will eventually result in saving the group call record in the database, removing it from the cache store, and recycling the sarah group call id.

While in the group call, the participants can press * to cast a vote for the group call room. The request is immediately executed and the caller is returned to the group call. Moderators cannot vote for the group call.

Any moderator can press # to mute everybody else in the group call, then press # again to restore the normal functionality (everybody can speak and be heard).

At the end of the call, the [pxx_room_call_ani] KVP is deleted, and is replaced with a [pxx_room_cdr_callid] KVP the CDR KVP has a limited time-to-live, and is picked up by an out of band process that transforms it into a database record.

A call cleanup procedure periodically counts the remaining active calls in a group call room, and places the group call record in a “no callers” state by writing the no_callers property of [p_service_did]. The same cleanup procedure processes the group call clearing after a reasonable timeout.

### Example 4

### Mobile Cast

A mobile cast is a type of group call initiated by a host, in which typically the host is the single talker. The host can invite, temporarily, one more listener to talk. Listeners can ask to get invited to talk by pressing the # key while in the group call (“raising hand”). When the host wants to invite a listener to talk, they press # themselves; the listener that has been waiting their turn the longest gets selected. While the host and one listener are both talking, the host can once again press # to set the talker back in listen-only mode, or 0 to ban the listener from the show (which the host may be asked to confirm). A ban can be for the current show only (the caller will not be selected again for talking), or for the current show and all future shows (the caller is disconnected and added to the mobile cast's blacklist).

While in the show, the listeners can press the * (star) key to cast a vote for the mobile cast. The mobile cast ratings are established based on the number of votes received. Mobile casts can be public (anybody can dial in) or private (access is either by invitation, or by using an access code).

During a mobile casts, the system pushes audio commercials, played to all the talkers (optionally the system may be configured to play stats to the host during this time-like audience, number of listeners waiting to talk, etc.). The commercials are automatically pushed at preset intervals of time; prior to the commercials barging in, warning beeps are played to the host. The system may be configured to adopt revenue-sharing deals with hosts that gather large audiences, in which case the hosts may be the ones selecting when and what commercials will play.

The host is able to terminate a show by pressing 9 (will be asked to confirm). Optionally, the system may offer the audio feed of the mobile cast as a public or private accessible audio stream, in listen only mode, with a computer audio player or DID.

Furthermore, the system may play the recording of the last show to the caller, if they call the show while the host is not on. Also, if the show is scheduled, the system may offer a “capturing menu” for the listeners that call in a few minutes before the show is supposed to start.

### Example 5

### Mobile Cast Call Handling

The corresponding [p_service_did] section features, under the sarah variables section, in addition to the standard variables may be designed to contain the following variables:

offtime—an audio file that is played to regular participants, if they call into a mobile cast when there is no show ongoing; usually this is the recording of the last show. If there is no value assigned, the prospective listener's call is nicely rejected.

host—ANI (user id) of the host

showmaxduration—maximum duration of a show, in e.g., seconds

In addition to the fields described in the common call handling section, the call record named [pxx_station_call_ani] is expected to have, before the call is received:

role—whether the user is a host or a regular listener

Also, once the call is answered, the following fields are created in the call record:

t0—timestamp when the call started

channel—channel id assigned by sarah

callid—unique id of the call, composed of:
first character of the site name
first character of the node name
a timestamp identification, like YYMMDDHHNNSS
2 random characters

starred—indicator of whether the caller pressed the star key to rate the station

The call id also represents this call's log filename, which may be searched for in the corresponding subdirectory made by MMDD-HH.

A “replace” operation may be used to adjust the value of this key (such that it would fail if the key doesn't exists), and a timeout value equal to the maximum call length.

If the caller is determined to be the host, the service KVP [p_service_did] is updated. The show record is typically available for the duration of the current radio show, and contains:

GroupCall—the internal sarah group call id; this is a 5-digit random number, between 10000 and 99999, chosen at the time the KVP is created; it is also appended in a KVP called [p_GroupCalls], so the system avoids generating duplicate id's. The group call number will be removed from the live group calls list once the show is over.

t0—time when show got started

host—the key of the host's call record

talker—the key of the listener's call record that currently has the right to talk; empty string if only the host is on

listeners—comma-separated list of listeners' call record keys; this list can take duplicates (e.g. a listener hangs up and calls again)

raised_hands—a comma-separated list of talker ANIs, for the callers that want to talk; the call keys will be added at the end of the list, so the call waiting the longest will be at the top of the list.

bans—a comma-separated list of talker ANIs, for the callers that have been temporarily banned (restricted from talking in the show); if a call is featured in this list, its name will not be added to the raised-hands member.

no_callers—timestamp of the first time the show was detected as having no callers connected; this will start a countdown that will eventually result in saving the show record in the database, then removing it from the cache store and recycling the group call id. The host call gets the group call started. The host can press #, which means connect/disconnect the next listener waiting to talk, or 0, which means ban the listener currently talking. The banning invokes a menu that says “press 1 for temporary ban, 2 for blacklisting, 0 to cancel the ban and return.” Also, key 9 pressed by the host means forcefully ending the group call (a request also confirmed with a voice menu). Listeners can press * to cast a vote for the show, and # to be considered for talking into the show (“raise hand”). Each of these requests is immediately executed and the caller is returned to the group call.

At the end of the call, the [pxx_station_call_ani] KVP is deleted, and is replaced with a [pxx_station_cdr_callid] KVP. The CDR KVP has a limited time to live, and is picked up by an out of band process that transforms it into a database record.

A call cleanup procedure periodically counts the remaining active calls on a station, and places the show record in a “no callers” state by writing the no_callers property of [p_service_did]. The reason why the record is not immediately removed is that the show host may have accidentally disconnect, so the system will keep the listeners connected for another while and give the host time to rejoin. The same cleanup procedure processes the group call clearing, after a reasonable timeout.

### Example 6

### Topic Talk

Based on their selections on their phones, callers will get to chat 1-on-1 with other callers that entered the same interest area. The service names, in the topic talk paradigms, are therefore equivalent to “interest areas.” In each interest area the system defines a set of partners-matching criteria; each criteria can have a limited set of values. E.g., a matching criteria can be “gender,” and its values can be “male,” “female,” and “undisclosed.”

Each user defines his own values for the matching criteria (own data); also, prior to the call, each user will indicate stronger or weaker preferences for getting in contact with callers with a specific set of values for the matching criteria. The 1-on-1 connections in a chat area are brokered by a matching algorithm, implemented in an out-of-band process called “the matchmaker.”

### Example 7

### Call Handling

The corresponding [p_service_did] section features, under the sarah variables section, in addition to the standard variables:

maxconn—the maximum duration, in seconds, a connection between two callers lasts.

In addition to the fields described in the common call handling section, the call record named [pch_area_call_ani] is expected to have, before the call is received:

membership—the caller's membership level e.g.: “none,” “registered” (default), “premium”

own_matching_data—the caller's data for the matching criteria: other calls will use this data and will evaluate how well this call matches their preferences; dictionary of <criteria_code>=><value>

criteria—matching criteria dictionary, the way the user indicated their preferences before calling: dictionary of <criteria_code>=><weight>,<value>

blacklist—a list of ani's that were previously blocked by this caller; these ani's will be disqualified for any connection

conn_history—list of calls previously connected to this call (array of call keys).

Also, once the call is answered, the following fields are created:

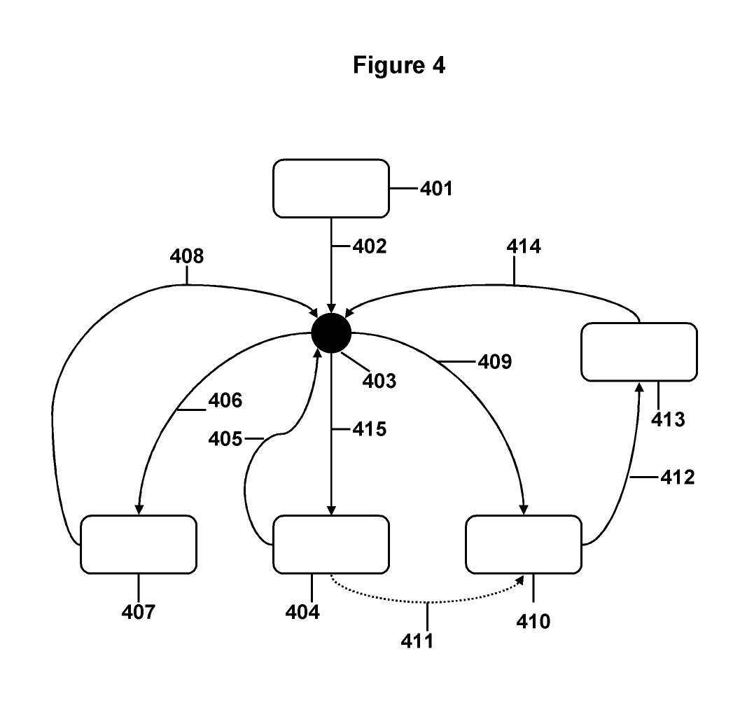

status—call status (see the state diagram FIG. 4): pre 401/conn (conversation) 410/miniwait (simulated search) 404/wait (commercial) 407, initially set to prematches—a list of calls that match the user preferences, updated and maintained by the matchmaker (array of call keys)

pending_connection—another call sets this parameter to its own id, based on a connection decision made by its matchmaker

In addition to updating the call record, the key of the call record plus a trailing comma is added to a “list of calls” KVP [pch_area_calls]; as a result, this KVP maintains a comma-separated list of active calls, which is used by the matchmaker each time it goes out to evaluate matching scores.

After going thru the initial common steps, the call is placed in the wait-connect loop, initially in a wait state.

The wait state is an artificially induced delay of a few seconds between 2 successive chat connections. Without having a wait state, theoretically a call would get connected to a next party as soon as it gets disconnected from the previous one. As an effect, all calls would be one-on-one connected, and an odd call would have nobody to connect to. Depending on the system load, the wait state can be anything from a couple of seconds of silence, to a dozen seconds needed to play a prompt like “please wait to connect you to the next person”, and to a variable time required to play an audio commercial.

At the end of the wait period, the call's own “pending_connection” parameter is tested, to see if the call was elected for a connection by another call; if it was, the connection is made right away.

If “pending_connection” is empty, the “matches” list is probed, and the first call on the list that is in a wait mode itself is selected for a connection (therefore that call's “pending_connection” parameter is written with the present call's id).

Some more delay may need to be added if the peer call currently plays an audio prompt; the delay enables the completion of the play operation.

While 1-on-1 connected, the callers have the following options:

# to get disconnected and placed in a wait state for the next connection

*1, *2, . . . , *5 to rate the user on the other end of the call with 1, 2, . . . , 5 stars (each entry overrides the previous one)

0 to report an inconvenience; upon pressing 0, a voice menu will ask to define the inconvenience, like for example “press 1 to report off-topic, 2 for foul language” and so on. After collecting the report, the caller is asked whether they want to get another partner, or be placed back in the conversation

1, 2, . . . , 9 to play predefined and prerecorded audio prompts in the conversation.

At the end of the call, the [pch_area_call_ani] KVP is deleted, and is replaced with a [pch_area_cdr_callid] KVP. The CDR KVP will have a limited TTL, and will be picked up by an out of band process that will transform it into a database record. Also, the call key is removed from [pch_area_calls].

### Example 8

### Call State Diagram

The call states diagram is walked by either sarah walking the call thru the states itself, according to the dial plan and/or asynchronous events, or by decisions made by the main connections decision algorithm inside the peer script. The peer script is invoked almost every time a call changes state. It analyzes the call data, detects the opportunities for connections, and moves the call to a new state. FIG. 4 is a call state diagram.

Initially, after the call was received, and while caller is been identified as a legitimate user, the call (“this” call) is in a pre state 401. The peer script is called for the first time to identify any possible connections 403. Here the logic is built into the script.

It first goes to obtain this call's record from the data store. Failure to obtain it indicates a bad error and the call will be terminated with a system error—this state is not illustrated here.

It will then determine whether another call has already selected the current call (“this” call) as a main preference. This information is derived from the pending_connection parameter, which represents the peer call that it selected, if it did, and that peer call is in a miniwait (or, less probably, wait) state 404, and the ANI of that call is also not present in blacklist, the script exits immediately thru the “booked BY other peer” branch 415, 405. It will signal to sarah by filling in the peer and peerchan dial plan variables with the call that gets connected 411, and the peer channel id. sarah will connect the two channels together and place them both in conn state 410. (Note: this may be a little counter-intuitive: even though the peer call selected this call to connect to, it is this call that initiates the bridging command.)

If there is no peer waiting for this call, or the peer has meanwhile disappeared (connected to something else or gave up), the current call will start examining its own list of preferences, stored in its matches parameter. The desired effect is to obtain the most preferred call to connect to. The top candidate for a selection is the first call in the (sorted) matches list that is in a wait or commercial state, has not been selected by another call (i.e. its pending_connection parameter is empty) and its ANI is not in the conn_history list or in blacklist. The peer script sets the peer's pending_connection parameter, places this call in the miniwait state, and exits thru its “booked other peer” branch. It signals to sarah the appropriate course of action by setting the peer dial plan variable to the peer call identifier (but leaving the channel dial plan variable empty). The miniwait state practically holds this call in a pre-connection state, until the peer finishes a wait or commercial cycle; at that point, the peer call would go thru its own peer search, find out it was selected for a connection, and initiate the bridge as described in the previous case. However, because the system does not want to ditch the current call into an infinite miniwait state, once the miniwait audio finishes playing the system will send it back to the peer script 405. (Note: the duration of the audio played during the miniwait state should be chosen to be the maximum duration for any possible wait state. The prompt is thought to be something that can be decently interrupted in the middle.) If the previous step failed to select any existing call, the system will need to place this call in a waiting loop. Therefore the script sets this call's state to wait, 407 and exits thru the “no more peers” branch 406, with an empty peer dial plan variable. Sarah will announce the fact that it is searching for a peer, then play a prompt (typically hold music or a commercial). In this state, this call can be selected by other calls running their peer script for a connection 408; however, when this happens, the wait state will continue until the associated prompt(s) are played entirely.

Summarizing the state diagram (FIG. 4), beginning at the pre stage 401, a user enters the peer search 403. Due to decision making of the system 406 he may enter the wait 407 stage. He may, after entering another decision tree and based on changed conditions 408 renter the peer search. He may also enter a decision tree corresponding to a booked other peers algorithm 415 and enter a miniwait 404 (summarizing search), which he may either exit 405 back to the peer search or go 411 directly to the conversation 410. Alternatively, he may enter the conversation from the peer search 409. Exiting the conversation 412 he may optionally be presented with commercials 413 and then return 414 to the peer search.

### Example 9

### The Matchmaker

An out-of-band process may be used to establish the best connection fits for a call, based on the caller's preferences defined in the matching criteria, just before placing the call. Each incoming call spawns a matchmaker process, typically running on the same machine that handles the call. The matchmaker scans, at regular intervals, all the other calls in the same interest area, and uses a math formula to calculate a matching factor. The result of the process is a list of call ids, sorted with the best matching call first; this list is stored in the “matching” parameter of a call's KVP record.

Each call comes with: (1) the user's values for each of the matching criteria used in the interest area, even if some of these values are null or unknown; and (2) the user's graded preferences for the same matching criteria, as they want them to be found ideally on their chat peers. For a caller A, the matching score with a caller B is calculated approximately like: MS=Σ where the sum is across all the matching criteria defined for the area of interest;

WA is the weighted importance given by user A to that criteria; PA is the value of the criteria that A would like B to have; and

VB is the value for the criteria that B actually has.

The level of importance will be considered as an exponential curve: the least important indicated criteria would have a weight WA of 1, the next one a WA of 2, and so on in a progression like 1, 2, 5, 10, 20, and 50. etc. Obviously a lot of times the values are not just numbers, but merely random text, therefore the system would have to evaluate globally the delta expression PA−VB as a single value, which the system will call a score.

Because the weights and the pseudo-differences between the preferences and the matching criteria values are largely variable, the formula above will be translated to an algorithm that best fits the conditions of the interest areas. In other words, each interest area will come with its own particular algorithm to establish the matching score.

In an area of interest, the matching criteria are gender, age, category and distance. Having one preference as a top preference would mean giving it a weight of 10; second preference would get a weight of 5; and 3rd preference would mean a weight of 2. Now regarding the values of each criterion, user's gender can be either male or female, or undisclosed. A score for a match is 10, for an attempt to match with an undisclosed gender is 5, and for a mismatch is 0. For example, if the user's matching selection for gender is “male,” then another user whose gender is set to “male” would receive a score of 10, another user whose gender is “undisclosed” will get a score of 5, and a female user would receive a score of 0. The age category can for example, be under 18, 18-20, 21-27, 28-37, 38-49, and over 50. For a full age range match the score will be 10, an adjacent age range would be scored as a 7, a match with an “undisclosed” setting will be rated at 5, and no matches are scored with 0. The distance can be theoretically any number, and in our context the closer is the better. For practical purposes the system will consider ranges of up to 1 mile (score 10), 1-2 miles (score 9), 2-5 miles (score 7), 5-10 (score 5), 10-20 (score 3), 20-100 (score 2), 100-500 (score 1) and more than 500 miles (score 0).

If one pretends that there's a user X that has a top preference to be connected to a male, second preference would be the closest distance; and 3rd preference is for the peer to be in the 21-27 year old age category.

For User A, who is a male, 26, at a distance of 30 miles, the matching score is MS=10 *10+5 *2+2 *10=130. The first 10 is the weight of the gender preference. The second 10 is the score for a gender match; 5 is the weight of the distance preference, The match is scored with a 2 (the 30 mile distance falls into the 20-100 ml range); 2 is the weight for the age preference, Again, a full match with A's age scored at 10 points.

User B did not disclose his/her gender, age is 29, and is within a mile from user X's location. This means a matching score of MS=10 *5+5 *10+2 *7=114 (scores are 5 for matching with an undisclosed gender, 10 for being very close, 7 for being not in the desired age category but pretty close to it).

User C is a male, 23, within 1 mile distance, and gets the top score: MS=10 *10+5 *10+2 *10=170.

Thus, the matching preference order is C (most preferred), A then B.

What is claimed is:

1. A method for providing access to a conference call, wherein said method comprises:
(a) executing a set of computer instructions stored in a non-transitory medium, wherein said computer instructions comprise
i. a first module that when initiated transmits a call-in telephone number to one or more persons over a network; and
ii. a second module that is configured to receive telephone calls from a plurality of persons and to determine whether each telephone call is made from an authorized telephone number; and
(b) connecting a person to a conference call only if said person's call originates from an authorized telephone number.

2. The method according to claim 1 further comprising:
(a) receiving an identification of a set of one or more persons, and storing information corresponding to said set in a database, prior to executing said first module;
(b) receiving an identification of a desired time for a conference call, prior to executing said first module;
(c) transmitting an electronic communication over said network to said set of one or more persons, wherein said electronic communication comprises a notification of said conference call, said desired time, and an invitation to obtain said call-in number prior to executing said first module; and
(d) receiving a user telephone number from each of one or more persons from within said set, thereby forming a subset of persons, prior to executing said first module, wherein said subset of persons are the one or more persons to whom the call-in number is transmitted according to the first protocol.

3. The method according to claim 2 further comprising receiving an identification of a subject of said conference call, and transmitting said subject over said network to said set of one or more persons.

4. The method according to claim 3, wherein said transmitting of said electronic communication comprises sending at least one of a text message or an electronic mail message.

5. The method according to claim 4, wherein the invitation comprises a hyperlink.

6. The method according to claim 5 further comprising automatic population of a data field with a user's telephone number after activation of said hyperlink.

7. The method according to claim 2, wherein said subset of one or more persons comprises a first person located in a first country and a second person located in a second country and said first person receives a first call-in number and said second person receives a second call-in number, wherein said first call-in number and said second call-in number are not the same and the first call-in number represents an intra-national call for the first person and the second call-in number represents an intra-national call for the second person and the method further comprises joining together in a conference call all persons who have joined a conference by using either the first call-in number or the second call-in number.

8. The method according to claim 1, wherein during said conference call the volume of a person who is speaking that is heard by a person who is listening, is dependent upon physical proximity of the person who is speaking to the person who is listening.

9. The method of claim 1, wherein said system recognizes a person as a phone caster, wherein said phone caster has the ability to initiate and to terminate the conference call.

10. The method of claim 9, wherein said phone caster has a rating above a predefined level, and said rating corresponds to one or more of the phone caster's knowledge and likeability.

11. A method for establishing a telephone connection between or among persons comprising:
(a) receiving a selection of a topic of conversation from a person;
(b) transmitting to a plurality of persons an electronic communication over a network, wherein said electronic communication comprises a notification of a conference call, a desired time, information corresponding to said topic and an invitation to obtain a call-in telephone number;
(c) receiving an acceptance of said invitation from a subset of persons from within said set and dividing said subset into two or more subgroups, comprising a first subgroup and a second subgroup, wherein each subgroup comprises at least two members and providing members of the first subgroup with a first call-in number and members of the second subgroup with a second call-in number, wherein the first call-in number and the second call-in number are not the same;
(d) within each subgroup, identifying each person to each other person by a privacy protected handle; and
(e) providing each person with a ratings option, wherein said ratings option permits each person to provide feedback as to the quality of each other person on a conference call.

12. The method according to claim 11, wherein the privacy protected handle comprises one or more of a nickname, an alphabetic code, a numeric code or an alphanumeric code, wherein the handle does not indicate personal identification information of a person.

13. The method according to claim 11, wherein each subgroup consists of two persons.

14. The method of claim 13 further comprising receipt of a request to end a conversation with a first person and to commence a conversation with a second person who expressed interest in conversing about a topic.

15. The method according to claim 11, wherein said method limits the number of persons in a subgroup to a predetermined number.

16. The method according to claim 15, wherein said dividing comprises applying an algorithm, wherein said algorithm comprises applying one more criteria selected from the group consisting of location of the person, age of the person, religion of the person, political affiliation of the person, gender of the person, and education level of the person.

17. The method according to claim 11 further comprising transmitting a friend request received from a first person to a second person and if accepted by said second person, receiving from said second person a level of detail about said second person to which said first person may have access and providing access to said level of detail to said first person.

18. A method for permitting a person to solicit offers from merchants, said method comprising:
(a) receiving electronic data over a network that corresponds to a request for a good or a service from a person who has access to a platform and said request comprises at least one of an item name, an item description, a time, a location, a number of persons and a price or price range;
(b) receiving an identification of a group of one or more merchants from said person, wherein said identification comprises a merchant name and/or description of a type of goods or services offered by said merchant;
(c) transmitting said request and a privacy protected handle to all members of said group; and
(d) receiving a response to said request and transmitting: (i) at least one response to said person; and (ii) an option for the person to enter into discussions with the merchant.

19. The method of claim 18, wherein said person has a phone book stored in a database and said group of merchants are identified in said database.

20. The method of claim 18 further comprising offering the person the option of receiving electronic messages from the merchant.
